(19) United States
(12) Patent Application Publication
(10) Pub. No.: US 2024/0156290 A1
(43) Pub. Date: May 16, 2024

(54) DRINKING STRAW

(71) Applicants: Klaus Peter RAUNECKER, Ulm (DE); Philip FRENZEL, Aalen (DE)

(72) Inventors: Klaus Peter RAUNECKER, Ulm (DE); Philip FRENZEL, Aalen (DE)

(21) Appl. No.: 18/418,265

(22) Filed: Jan. 20, 2024

Related U.S. Application Data
(63) Continuation of application No. PCT/EP2022/069585, filed on Jul. 13, 2022.

(30) Foreign Application Priority Data
Jul. 20, 2021 (DE) 10 2021 118 669.2
Jul. 20, 2021 (DE) 20 2021 103 855.1

(51) Int. Cl. A47G 21/18; F03G 7/06

(52) U.S. Cl. CPC A47G 21/18; F03G 7/06143

(57) ABSTRACT

A drinking straw with a cavity extending between two open ends of the drinking straw and surrounded by a wall. The wall has a division extending between the ends which makes it possible to open the wall along the division. The drinking straw comprises an actuating element which is set up to open the wall along the division as a result of at least partial heating of the drinking straw or to open on the basis of at least partial heating of the drinking straw above a specific temperature.

This nonprovisional application is a continuation of International Application No. PCT/EP2022/069585, which was filed on Jul. 13, 2022, and which claims priority to German Patent Application No. DE 10 2021 118 669.2 and German utility model 20 2021 103 855 U1, both filed on 20 Jul. 2021, and which are all herein incorporated by reference.

### BACKGROUND OF THE INVENTION

### Field of the Invention

The present invention relates to a drinking straw.

### Description of the Background Art

Drinking straws of the type in question are used for the consumption of drinks by people, in particular cold drinks such as long drinks or cocktails. They have two open ends, between which a wall extends that surrounds a cavity. As a rule, such drinking straws are elongated.

In the past, such drinking straws were usually manufactured and offered as disposable items, particularly made of plastic. More recently, this type of straw has been banned by many countries, particularly the European Union, due to the associated environmental problems.

This created the need for reusable drinking straws, but in particular the problem of cleaning used straws. Due to the fact that the drinks are sucked through the cavity when the straw is used, the dirt on a straw is also regularly found on the inside of the wall after it has been used as intended. However, this is only accessible through the two open ends. However, the openings at the open ends only have a small cross-section. In particular, the cross-section of the openings is small compared to the length of such a drinking straw along its main direction of extension between the ends. The main direction of extension is to be understood here in particular as the direction along the drinking straw in a respective section of the overall extension of the drinking straw between its ends, since such a drinking straw may well have curved shapes.

These spatial conditions of a typical drinking straw make it difficult to clean. Particularly during automated cleaning, for example in a dishwasher, the cleaning medium regularly does not reach all parts of the inside of the wall to a sufficient extent. In this context, the person skilled in the art speaks of the so-called “rinsing shadow”, which refers to areas that are not reached by the cleaning medium during the rinsing process, for example in the dishwasher, or at least not to a sufficient extent. This “rinsing shadow” represents an obstacle to the multiple use of drinking straws. Furthermore, the capillary effect in the drinking straw can also lead to detergent residues remaining in the drinking straw.

A solution to the problem described is disclosed in the German utility model DE 20 2018 1 06 851. In the utility model mentioned, a drinking straw is shown whose wall has a division extending between the ends of the drinking straw. This division makes it possible to open the wall along the division, thereby improving the accessibility of the cavity for cleaning purposes.

However, the solution shown in the prior art has the problem that the drinking straw has to be opened and closed manually for both the rinsing process and its use.

### SUMMARY OF THE INVENTION

It is therefore an object of the present invention to provide a drinking straw that can be cleaned more easily, in particular in dishwashers, without additional manual work.

A drinking straw according to an example of the invention has a cavity extending between two open ends of the drinking straw and surrounded by a wall, wherein the wall has a partition extending between the ends, which enables the wall to be opened along the partition. The drinking straw comprises an actuating element which is designed to cause the wall to open by heating the drinking straw above a specific temperature, at least in certain areas. In other words, heating the drinking straw above the specified temperature causes the drinking straw to open virtually automatically and the inside of its wall becomes accessible for thorough cleaning. Heating above the specified temperature typically takes place in a dishwasher, but can also take place during a manual rinsing process. To thoroughly clean the drinking straw, it is therefore sufficient to place it in a suitable dishwasher basket when closed. Just make sure that there is enough space around the straw to open it when it heats up.

The fact that the actuating element comprises a bimetal or a shape memory material, in particular a two-way shape memory material, means that the desired opening and closing process can be advantageously achieved. When the drinking straw cools below the specified temperature after the rinsing process, the drinking straw closes again automatically. It is also conceivable to use only the so-called one-way effect. In this case, a separate resetting element is advantageous.

The actuating element can at least partially comprise nitinol, the transition temperature of which can be adjusted over a wide range. Of course, other shape memory materials are also possible.

In particular, the specific temperature can be between 40° C. and 50°. This can ensure that the straws open during a rinsing process, but not at room temperature or due to a user's body heat. In the event that shape memory materials are used, the specific temperature may in particular be the phase transition temperature.

In particular, the actuating element can be integrated into the drinking straw; for example, the entire drinking straw can be made of the shape memory material.

The actuating element can also comprise a separate element. For example, the drinking straw itself can comprise commercially available stainless steel and only the separate actuating element can be formed using a shape memory material or a bimetal. In this way, a certain cost saving can be achieved in the manufacture of the drinking straw according to the invention. In particular, the actuating element can be designed in such a way that a material is bonded to the material of the drinking straw which has a coefficient of thermal expansion that differs from that of the drinking straw—in this way, a bimetal can be realized particularly easily.

The actuating element can comprise a sleeve that surrounds the wall at least in certain areas; in this case, the coefficient of thermal expansion of the sleeve should be lower than that of the drinking straw itself in order to ensure an opening when heated.

The sleeve can also comprise a handle and/or a hook element and be connected to the wall in a form-fit, force-fit or material-fit manner.

The tightness of the drinking straw according to the invention in the closed state can be improved by providing the wall with an elastic prestress which counteracts an opening of the wall. In this case, it is advantageous if the force exerted by the actuating element above the specified temperature is sufficient to open the drinking straw against the elastic pretension.

The tightness can be further improved in the closed state by the drinking straw having a cross-section corresponding to the cross-section of a lens, i.e. deviating from the usual hollow cylindrical shape. In other words, the drinking straw can comprise two concave grooves that are connected to each other in such a way that the concave sides face each other and thus form the cavity. The end faces of the wall facing away from the division are firmly connected to each other, for example by the two channels being made in one piece in this area or being connected to each other by a material bond, for example by laser welding. The described geometry of the drinking straw also means that unwanted rolling of the straw on a surface such as a sideboard or counter is avoided. Furthermore, the outer surface of such a drinking straw, which is flatter in some areas than the cylindrical shape, is more suitable for applying advertising or the name of the associated catering establishment, for example.

In particular, the end faces of the wall facing the partition can be designed in such a way that they run parallel at least in sections, which further increases the tightness in the closed state.

In particular, the end faces facing the partition can be designed at least in sections in such a way that, in the closed position, there is at least a partial positive fit between the end faces. For example, the end faces can be stepped, resulting in a positive fit in the manner of a labyrinth seal.

The tightness can be further improved by the fact that an elastic sealing element is arranged in the area of the end faces facing the partition.

A resetting element can be provided which is designed to close the wall along the pitch when the temperature falls below a resetting temperature. As already mentioned, this is particularly useful in cases in which the one-way effect of a shape memory material is used. The resetting element can, for example, comprise a spring steel or a superelastic shape memory material.

In particular, the resetting element and the actuating element can be mechanically connected to each other.

The resetting element and/or the actuating element can each comprise wire or rod shaped elements.

The resetting element and the actuating element can together form a grid or web-like composite structure.

Furthermore, one of the two elements can be flat and the other element can comprise wire or rod-shaped elements.

In particular, the flat element can be the resetting element.

At least one of the wire or rod shaped elements can be guided through at least one aperture from a first to a second side of the planar element. Furthermore, at least one of the wire or rod shaped elements can be inserted into at least one elongate recess of the planar element.

It is also possible for at least one of the wire or rod shaped elements to be arranged on a surface of the flat element.

The end faces of the wall facing the partition can each be convex; a first end face of the wall facing the partition can also be convex and a second end face facing the partition can be concave.

When closed, the wall of the drinking straw can form an overlapping area.

It can be useful for individual applications for the pitch to have a spiral shape.

Furthermore, the graduation may comprise a plurality of radial incisions and the actuating element may be arranged to deform the drinking straw about an axis perpendicular to its longitudinal extension. In other words, the drinking straw in this case comprises a plurality of hollow cylindrical partial segments along which the actuating element runs in the axial direction. The partial segments can also be connected to one another in the area of the actuating element, in particular in one piece.

The resetting element can be arranged along the drinking neck in the axial direction opposite the actuating element. In particular, the resetting element, actuating element and wall can also be arranged in alignment with each other.

The resetting element can also be arranged along the drinking straw in a radial direction opposite the actuating element. In this case, a tensile load also occurs in addition to the pure bending load.

The actuating element and/or the resetting element can at least be partially integrated into the material of the wall. Thus, the actuating element and/or the resetting element can be completely surrounded by the material of the wall.

The material of the wall can be a plastic, in particular a silicone rubber; the actuating element and/or the resetting element can be injected or molded into the material of the wall.

Increased safety against incorrect use of the drinking straw can be achieved by the positioning element being arranged in at least one end area of the drinking straw, in particular in both end areas.

If the straw is mistakenly used for hot drinks, the unfavorable case could occur that the straw opens at an unfavorable moment, which could lead to contamination in particular.

The end area can comprise the 30%, in particular 20%, in particular 10% of the longitudinal extension of the drinking straw neighboring the respective end of the drinking straw.

The arrangement of the actuating element in the end area ensures that the straw opens as soon as it is mistakenly immersed in a hot drink. This makes it possible to recognize, at least visually, that the straw is not suitable for such a drink. Ideally, in this case, the straw opens to above the liquid level of the hot beverage, making it difficult or impossible for the user to suck in the beverage. This can be achieved, for example, by the control element extending over the entire length of the drinking straw.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of a drinking straw according to the invention,

FIG. 2 is a cross-sectional view of a drinking straw according to the invention in the closed position,

FIG. 3 is a cross-sectional view of a drinking straw according to the invention in the open position,

FIG. 4 shows an actuating element and a resetting element that are integrated into the material of the wall,

FIG. 5 shows an exemplary composite structure formed of a resetting element and an actuating element,

FIG. 6 shows an example of the invention,

FIG. 7 shows an example with an undulating resetting element,

FIG. 8 shows an example with a flat resetting element,

FIG. 9 is an arrangement from FIG. 8, integrated into the wall of a drinking straw,

FIG. 10 shows a modification of the example shown in FIG. 8,

FIGS. 11a to 11e show various end faces of the wall,

FIGS. 12a to 12f show different options for designing a course of the division,

FIGS. 13a and 13b show an example of a drinking straw according to the invention, and

FIG. 14 shows an example of a drinking straw according to the invention.

### DETAILED DESCRIPTION

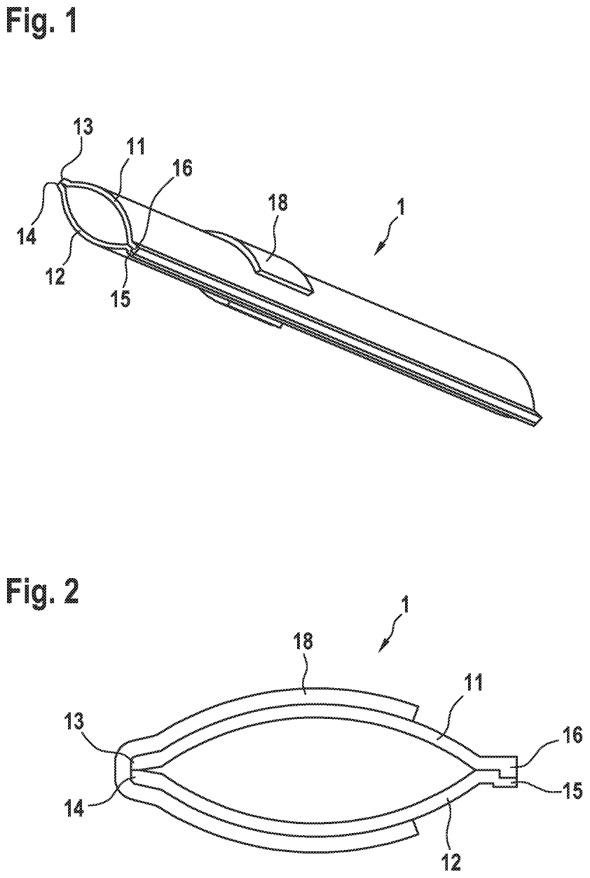

FIG. 1 shows a perspective view of a drinking straw according to the invention. The drinking straw 1 has a lenticular cross-section. This is achieved by the two concave wall elements 11 and 12, which in the example shown are connected along their first longitudinal edges 13 and 14 by a material bond, for example by a laser weld seam not separately labelled in the figure. It is also conceivable to manufacture the two wall elements in one piece, for example by bending or similar, from a single semi-finished product. The two longitudinal edges 15 and 16 of the two wall elements 11 and 12 are each provided with a shoulder which extends over their entire length and serves to improve the sealing of the drinking straw 1 according to the invention in the closed position.

Also clearly recognizable in FIG. 1 is the actuating element 18 in the form of a sleeve, which partially surrounds the two wall elements 11 and 12 from the side of the longitudinal edges 13 and 14. In particular, the actuating element 18 can comprise a shape memory material which causes the drinking straw to open when a specific temperature is exceeded. The actuating element 18 can also be designed as a bimetal or, together with the material of the wall elements 11 and 12, produce a bimetal effect if the respective thermal expansion coefficients are suitably selected.

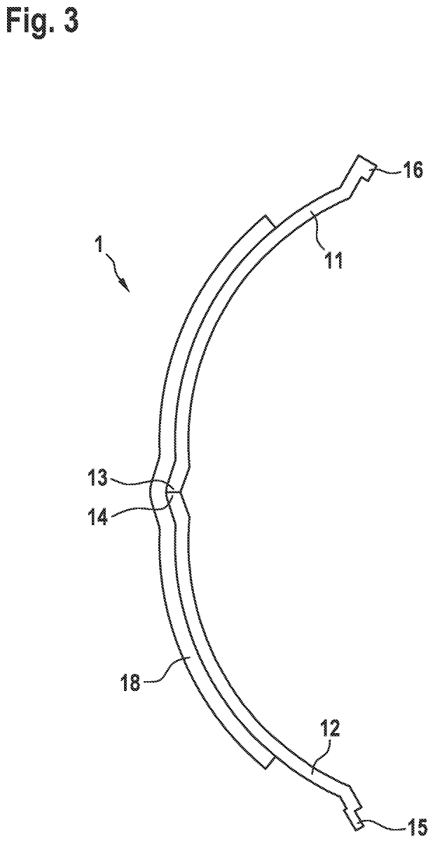

FIGS. 2 and 3 show the drinking straw 1 according to the invention once in the closed position (FIG. 2) and once in the open position (FIG. 3). The good accessibility of the insides of the wall elements 11 and 12 for cleaning purposes is clearly recognizable.

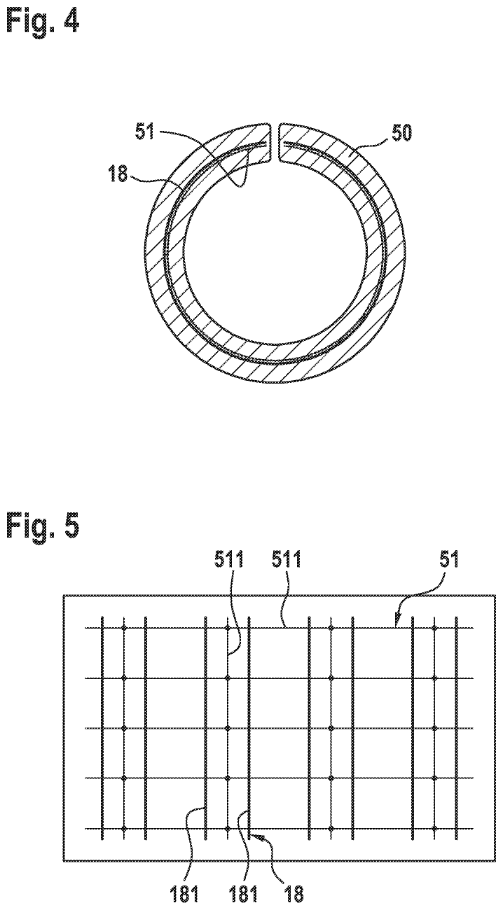

FIG. 4 shows a variant of the invention in which a positioning element 18 and a resetting element 51 are integrated into the material of the wall 50. In the example shown, both the resetting element 51 and the actuating element 18 are completely surrounded by the material of the wall 50, for example injected or molded in. The material of the wall 50 can, for example, be a plastic, in particular a silicone rubber. It is also conceivable to make the wall 50 metallic, for example from an aluminum material, and to cast the actuating element 18 or the resetting element 51 into the metallic material. A particular advantage of the solution shown in FIG. 4 is that the outer shape of the drinking straw according to the invention is completely smooth and therefore easy to clean.

An exemplary composite structure 60 comprising resetting element 51 and actuating element 18 is shown in FIG. 5. Clearly recognizable in the figure is the grid-shaped or web-shaped design of the composite structure 60. In the example shown, the resetting element 51 and the actuating element 18 each comprise wire-shaped or rod-shaped elements 511 and 181 respectively, which are arranged in a grid-shaped or web-shaped manner. It is clearly recognizable in the figure that individual elements 511 of the resetting element 51 are surrounded on both sides by individual elements 181 of the actuating element 18. The individual elements 511 of the resetting element 51 can be connected to each other as indicated in the figure by the unlabeled points.

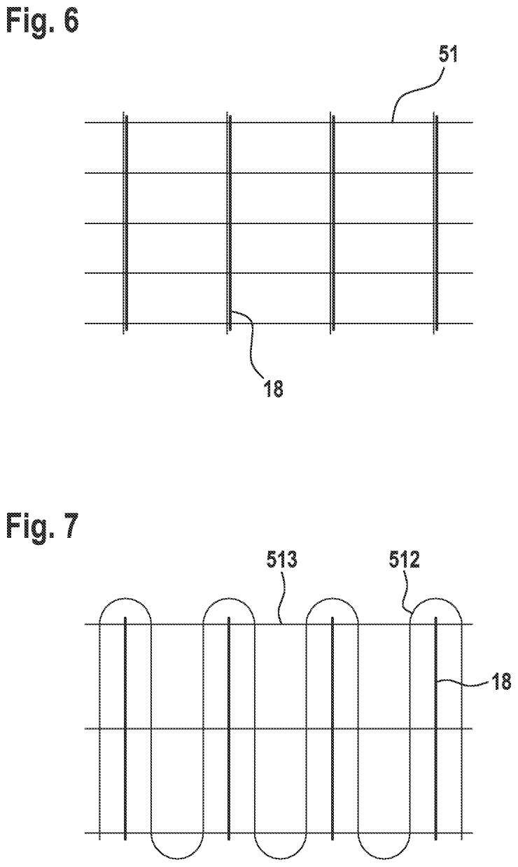

FIG. 6 shows a variant of the invention in which the actuating elements 18 are designed directly adjacent, in particular mechanically connected, to the resetting elements 51. This example of the invention has the particular advantage that the force exerted by the resetting elements 51 on the actuating elements is exerted directly, i.e. without being mediated by an intermediate material. In the case of embedding in a plastic or silicone wall, for example, this can prevent the formation of a ripple in the wall due to the mechanical properties of the wall.

FIG. 7 shows an example in which a resetting element 512 is designed as an undulating element. Further resetting elements 513 run straight, in the example shown orthogonally to the setting elements 18.

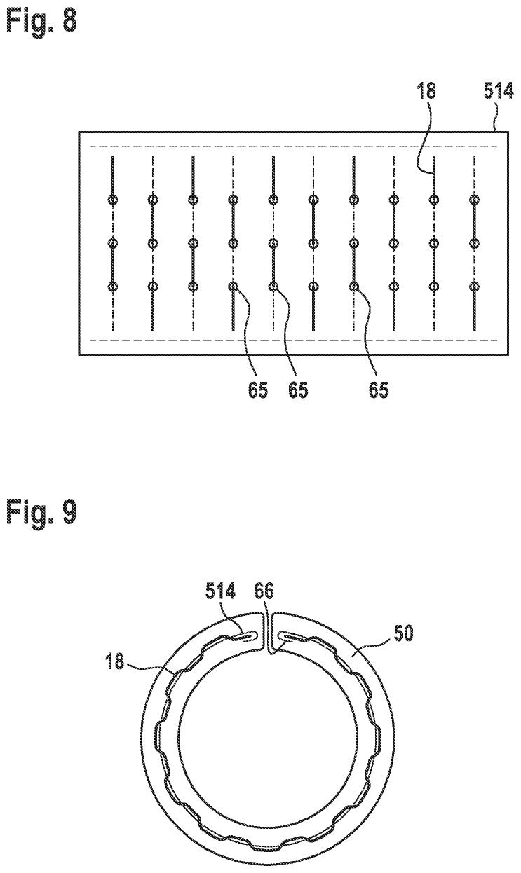

In the example shown in FIG. 8, the resetting element 514 is flat, for example made of a spring steel sheet or a super elastic material. In the example shown, the actuating elements 18 are guided through openings 65 in the resetting element 514 from one side of the resetting element to the other.

FIG. 9 shows an example of the arrangement shown in figure eight, integrated into a wall 50 of a drinking straw. A beading 66 along the dashed line shown in FIG. 8 can be recognized in FIG. 9. The beading 66 has the effect of preventing damage to the end faces of the wall 50.

FIG. 10 shows a modification of the example shown in FIG. 8. In the variant shown in FIG. 10, the actuating elements 18 are inserted in recesses 68 in the resetting element 514, which is also of a flat design.

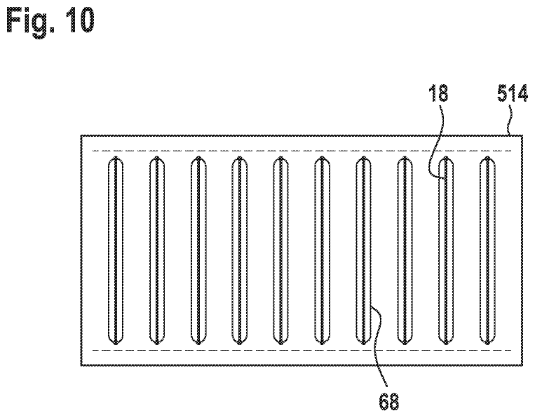

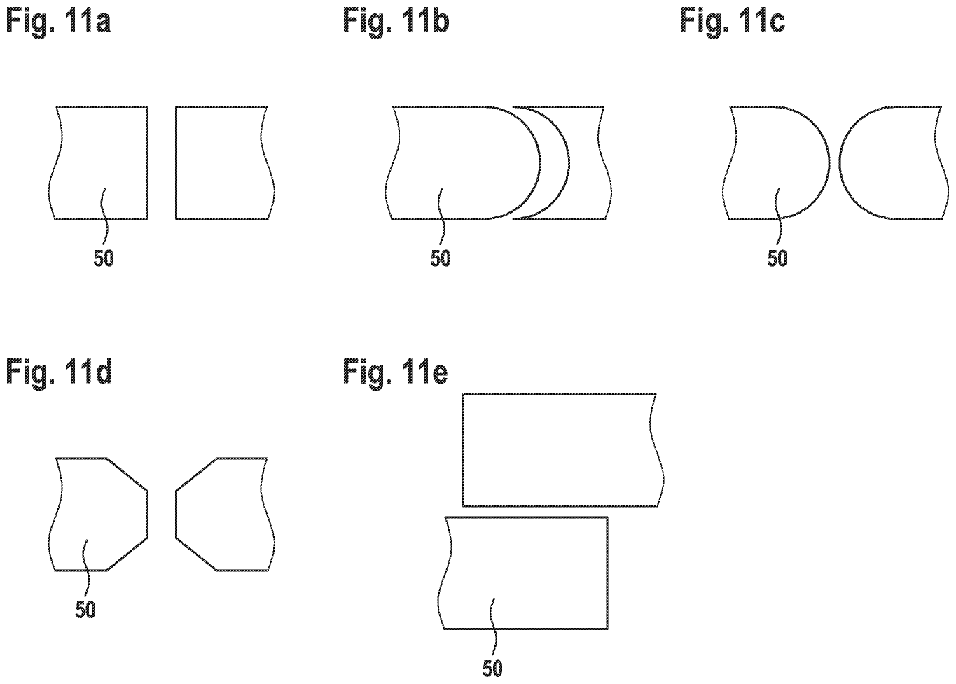

FIG. 11 shows in the partial FIGS. 11a to 11e various possibilities for designing the end face of the wall 50, e.g. flat on both sides (11a), convex/concave (11b), convex on both sides (11c), trapezoidal on both sides (11d) and overlapping (11e). It goes without saying that a large number of other design options for the end faces are conceivable.

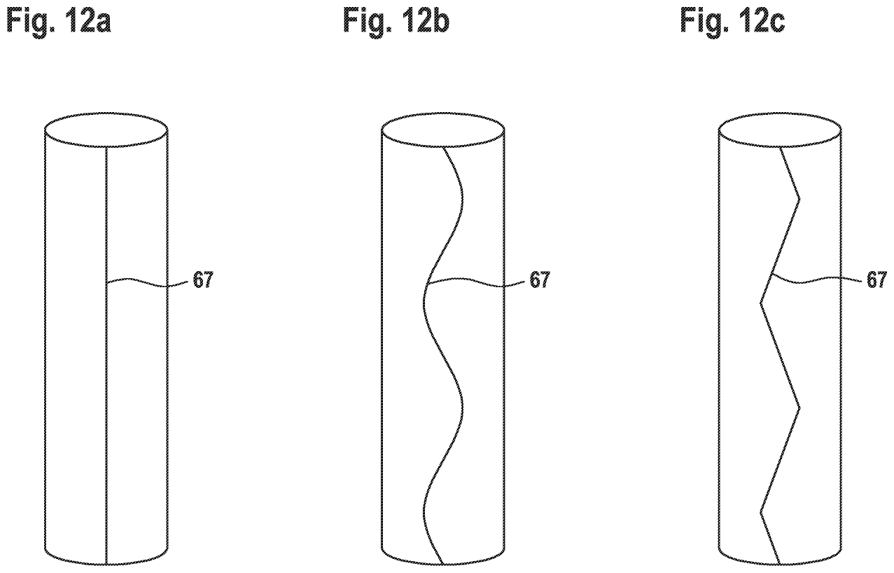

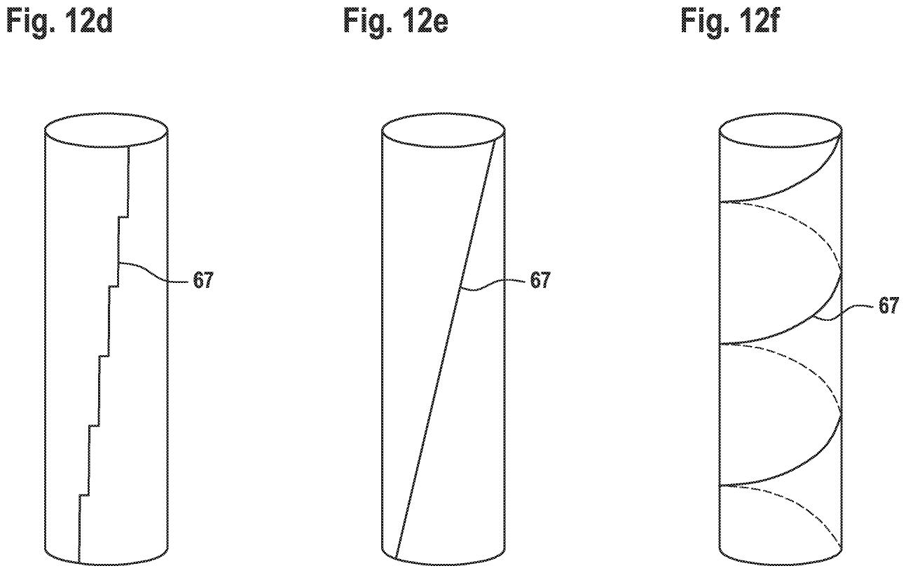

FIG. 12 shows various possibilities for designing the course of the graduation 67, namely straight (12a), wavy (12b), zigzag (12c), stepped (12d), sloping (12e) and spiraling (12f). Here, too, of course, other courses of the graduation 67 are conceivable.

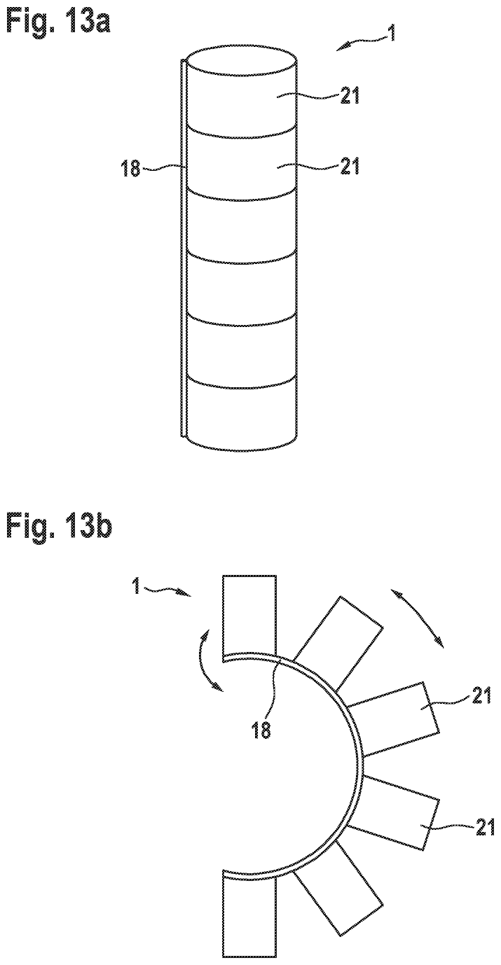

FIG. 13 shows in sub-FIGS. 13a and 13b an alternative example of a drinking straw 1 according to the invention. In the example shown, the drinking straw 1 comprises a plurality of hollow cylindrical sub-segments 21 along which the actuating element 18 extends in the axial direction. When heated, the actuating element 18 bends about an axis running orthogonally to the longitudinal axis of the drinking straw 1, so that the partial segments 21 are at least partially lifted away from one another, making the inside of the drinking straw 1 more easily accessible for cleaning.

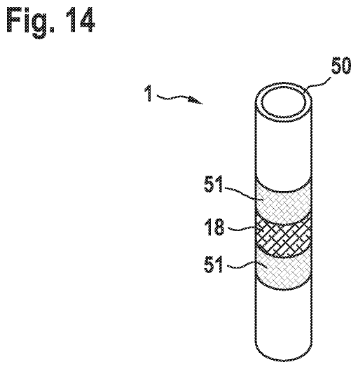

FIG. 14 shows an example of the invention in which the drinking straw 1 is hollow-cylindrical and both the actuating element 18 and the resetting element 51 are arranged in axial alignment with the wall 50 of the drinking straw, one behind the other. This variant has the advantage that pure bending loads and no tensile loads act on all the elements involved.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A drinking straw comprising:
a wall;
a cavity extending between two open ends of the drinking straw and surrounded by the wall, the wall having a division extending between the two open ends to facilitate an opening of the wall along the division;
an actuating element arranged such to cause the opening of the wall on the basis of at least a partial heating of the drinking straw above a specific temperature; and
a resetting element to close the wall along the division when the temperature falls below a resetting temperature.

2. The drinking straw according to claim 1, wherein the actuating element comprises a shape memory material.

3. The drinking straw according to claim 1, wherein the specific temperature is 40° C.

4. The drinking straw according to claim 1, wherein the actuating element is integrated into the drinking straw, or wherein the actuating element is a separate element that is not integrated into a material of the straw.

5. The drinking straw according to claim 1, wherein the wall comprises an elastic prestress that counteracts an opening of the wall.

6. The drinking straw according to claim 5, wherein a force exerted by the actuating element above a specific temperature is sufficient to open the drinking straw against the elastic prestress.

7. The drinking straw according to claim 1, wherein the resetting element comprises a spring steel or comprises a superelastic shape memory material.

8. The drinking straw according to claim 1, wherein the resetting element and the actuating element are mechanically connected to each other.

9. The drinking straw according to claim 1, wherein the resetting element and the actuating element each comprise wire or rod shaped elements.

10. The drinking straw according to claim 1, wherein the resetting element and the actuating element together form a lattice-shaped or web-shaped composite structure.

11. The drinking straw according to claim 1, wherein one of the two elements is flat and the other element comprises wire-shaped or rod-shaped elements.

12. The drinking straw according to claim 11, wherein at least one of the wire or rod shaped elements is guided through at least one opening from a first to a second side of a flat element.

13. The drinking straw according to claim 11, wherein at least one of the wire or rod shaped elements is inserted into at least one elongate recess formed on a flat element.

14. The drinking straw according to claim 9, wherein at least one of the wire or rod shaped elements is arranged on a surface of a planar element.

15. The drinking straw according to claim 1, wherein the resetting element is arranged along the drinking straw in an axial direction opposite the actuating element.

16. The drinking straw according to claim 1, wherein the resetting element is arranged along the drinking straw in a radial direction opposite the actuating element.

17. The drinking straw according to claim 1, wherein the actuating element and/or the resetting element are formed at least partially integrated in a material of the wall.

18. The drinking straw according to claim 1, wherein the actuating element and/or the resetting element are completely surrounded by a material of the wall.

19. The drinking straw according to claim 1, wherein a material of the wall is a plastic or a silicone rubber.

20. The drinking straw according to claim 1, wherein the actuating element and/or the resetting element are injected or molded into a material of the wall.
